(19) United States
(12) Patent Application Publication
(10) Pub. No.: US 2013/0276370 A1
(43) Pub. Date: Oct. 24, 2013

(54) PHYTOREMEDIATION TEST CELL AND METHOD

(71) Applicant: Louis A. Licht, North Liberty, IA (US)

(72) Inventor: Louis A. Licht, North Liberty, IA (US)

(21) Appl. No.: 13/450,944

(22) Filed: Apr. 19, 2012

(51) Int. Cl. A01G 9/02

(52) U.S. Cl. 47/66.7; 47/79

(57) ABSTRACT

The invention is a phytoremediation test cell that mimics mature plant remediation properties. The test cell allows a test of the accuracy and efficiency of phytoremediation by placing the trees that are to be used for phytoremediation in a contained elongated cavity filled with the soil or root medium that is to be phytoremediated. The cell has a drain outlet at its bottom that water poured through the cell is in contact with the roots of the phytoremediating plant and then drains through the outlet such that it can be tested. The plants are 8-10 months old and arranged in the cell such that their roots are surrounded and in direct contact with the root medium.

### BACKGROUND OF THE INVENTION

Over the years there has arisen increasing concern on the part of scientists, environmentalists, and the general public as to the condition of our environment, and the adverse impact that humans have had upon it. Some of this concern has been directed toward the destruction of forests and trees which provide oxygen for our atmosphere, and toward the introduction of environmental pollutants, especially those entering surface water and ground aquifers that eventually supply drinking water. Pollutants can be from point sources, like a pipe, or they can be non-point sources such as runoff from urban streets or diffuse leakage from soil. Non-point source pollutants are currently a major contaminant source in American drinking water. A number of pollutants enter waterways as a result of the use of chemicals on crop land. This is especially true of nitrate-nitrogen and phosphorous used as fertilizers on crops. In agricultural states such as Iowa for example, nitrate-nitrogen is the number one pollutant of drinking water exceeding EPA-defined drinking water standards. The nitrogen fertilizers are but one of a number of chemicals that are injected in or on the soil or sprayed on crops, and then enter the near surface ground water and travel to nearby streams and therefore ultimately may reach drinking water supplies. Other ground water pollutants include pathogens and, pharmaceuticals, and viruses.

Once in the drinking water supply, the most commonly used method of removing such pollutants is to treat the water at treatment plants before it is presented to the general public. Often such treatment is not done due to expense for nitrate-nitrogen removal, resulting in public exposure of nitrate-nitrogen in the drinking water supply. This is only one example of the numerous pollutants which can enter ground water supplies causing contamination.

Denitrification is not considered in the agronomic rate calculation though it can remove more nitrogen from saturated soil than crop uptake.

Soil microbes use nitrate-nitrogen with sufficient carbon in anoxic conditions to produce di-nitrogen gas—which is innocuous. When excess water is irrigated and percolates downward, there is a potential for soluble nitrate percolation through a shallow crop root zone.

The following equation for the microbial reaction of nitrate-N with organic biomass and acid (H⁺) is fundamental to denitrification (C H₂O is approximate chemical equation for polysaccharides, i.e., starches, cellulose, sugar):

C H₂O+4NO₃⁻+4H⁺->5CO₂(gas)+2N₂(gas)+7H₂O

Thus, 60 grams of available organic carbon in decomposing biomass, more soluble sugar or root exudates react with 56 grams of nitrate-N plus 4 grams of H⁺ (acid) produces 5 molecules of carbon dioxide, 2 molecules of di-nitrogen gas and 7 molecules of water.

For every 1,000 pounds of available nitrate-N in irrigated POM waste water, denitrifying microbes would require 1,071 pounds of carbon as ‘food’. This reaction requires sufficient time and microbial activity in the root zone for soluble nitrate-N removal from the water and conversion to nitrogen gas. With insufficient carbon, denitrification in deeper soils cannot occur quickly enough resulting in nitrate entering the near-surface aquifer.

Less expensive and alternative means to treatment plants is use of phytoremediation, particularly using trees in the Salicaceae family, such as poplars. See, for example, Dr. Licht's own previous U.S. Pat. No. 6,254,327 issued Jun. 26, 2001 and U.S. Pat. No. 5,947,041 issued Sep. 7, 1999. These are not the only patents that are known to deal with phytoremediation processes to remove pollutants from ground water by rapid uptake into root system of fast growing plants. See, for example, U.S. Pat. No. 5,829,192; U.S. Pat. Nos. 5,928,191; 6,189,262 B1; 6,205,708 B1; and 7,272,911 B2.

There is within the remediation industry some skepticism about use of phytoremediation as opposed to more expensive and elaborate remediation systems developed by civil engineering firms like treatment plants, lagoons, etc. That is to say, use of phytoremediation to, for example, to remove phosphates and nitrates from soil to protect the ground water is so inexpensive compared to civil engineering designed systems that some doubt its efficiency or its adequacy to do the job, especially in dormant season.

There is, therefore, a need to develop a test cell, preferably portable, that allows one to standardize and measure specified regulated parameters to access effectiveness of phytoremediation. Doing so assures prospective purchasers of the full scale operability and efficiency, despite its low cost.

The test cell if constructed right could measure and control media, dose of water, source of water, phreatic surface elevation, tree species, tree root depth, etc.

There currently is no such test cell available. The Gatliff U.S. Pat. No. 6,189,262, uses contained poplar trees within modular cubes for phytoremediation; but it also uses small diameter tubes to individually surround the deep root systems of the trees and these confined surrounded root capillaries prevent adequate contact with the surrounding soil to be used for a test cell system.

It is therefore a primary objective of the present invention to develop a test cell which allows for testing of phytoremediation for any particular soil, water, or gas containing contaminants of concern (COC), which is a candidate for being remediated, in order to determine the effectiveness of phytoremediation at removing pollutants such as phosphorous, nitrogen, PCB, PAH, pathogens, pharmaceuticals and even petrochemicals.

It is another objective to develop a portable test cell which can be conveniently carried from site to site.

It is a further objective to provide a test cell which provides phytoremediated effluent which can be tested to provide chemical evidence (data) of effectiveness of use in the very soil of interest, and can be used in a mode to test contaminant removal from the soil.

An even further objective is to provide a method of test cell use to allow site test effectiveness for phytoremediation techniques, installed with sufficient duplication to allow comparison between construction variable and operating variable for year-round testing before full scale construction.

The means and method of accomplishing these and other objectives of the present invention are disclosed in the written description which follows.

### SUMMARY OF THE INVENTION

A phytoremediation test cell that mimics mature plant remediation properties in 60 growing days. These test cells can be grown using any plant such as coniferous trees, deciduous trees, nature grasses, wheat and other commercially grown agricultural crop.

The test cell is designed fundamentally to allow planting Salicaceae trees, Populous (Poplar) and Salic (Willow), to provide a consistent root zone. The test cell allows a test of the accuracy and efficiency of phytoremediation by placing the trees that are to be used for phytoremediation in a contained elongated cavity filled with a medium that allows root growth and expansion throughout the media so a root penetrates every cubic inch of medium volume. The drain can be either a gravity drain through the base sideways through a valve and out, or it can be a pumped drain with the drain on the test cell floor can be pumped to the surface to remove and sample percolated water. The cell has a drain outlet at its bottom. Water poured into the cell is in contact with the roots of the phytoremediating plants and then drains through the outlet, such that it can be tested to determine COC concentration. Water COC concentrations can be measured between inlet and drain to measure the effect of root zone exposure for a predictable dwell time. The plants are preferably at least two months old and arranged in the cell such that their roots are surrounded by and in direct contact with, the root medium. The cell can optionally be used in a drain closed mode to test uptake of pollutants from the media.

### BRIEF DESCRIPTION OF THE DRAWINGS

FIG. 1 is a graph of an example showing E. coli removal by 8 month old poplar roots in a test cell using various soils as the root medium.

FIG. 2 is a similar graph depicting effectiveness of the same plants at ammonia removal.

FIG. 3 is a perspective drawing of a suitable test cell with long stem poplar and willow.

### DETAILED DESCRIPTION OF THE INVENTION

This invention relates to a test cell designed to demonstrate the efficacy of phytoremediation as a practical, accurate, and inexpensive way to remove pollutants from waste, soils and gas.

An economical, viable, renewable tree crop provides a number of environmental benefits, such as a wind shelter, soil stabilization, wildlife habitat, carbon sequestration, and saving construction and operating costs when treating contaminants-of concern (COC) required by environmental regulations and performed by traditional civil engineering designed remediation systems.

The phytoremediation test cell itself can take a variety of physical forms as long as it is a containment cell with an open top and defining an elongated interior cavity, a bottom, and a drain outlet that can be optionally closed.

A phytoremediation test cell used in the prototype research is a 12 inch×12 inch×33-inch deep planting chamber filled with growing medium, planted with plants, irrigated with specific water, and allowed to grow a rhizosphere that mimics maturity in less than one year.

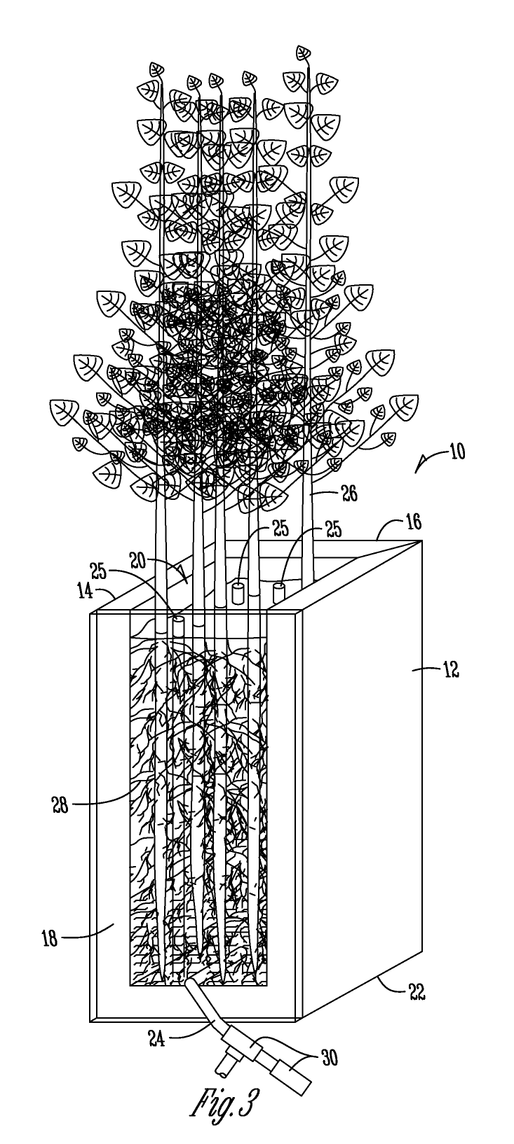

As shown in FIG. 3, the phytoremediation test cell can take a variety of physical forms as long as it is a containment cell with an open top and defining an elongated interior rectangular box 10 having side walls 12, 14,16, and 18, and open top 20, bottom 22.

If desired, one of the walls, say 18, can be see-through glass or plastic, for further effective demonstration to owners and regulators of COC.

Once such cell is shown in FIG. 3 can be made of wood, plastic, Styrofoam, etc. The interior cavity may be covered with an inner lining and the drain spout or pumped drainage pipe 24 may be made of inert material, and is optionally closeable. Tubes 25 can be inserted in the media at the time of planting to insulate part of the media from root-related chemical, biological and physical processes for comparison with the densely-rooted media.

Size can vary but a typical satisfactory size is 12′×12′×33 inches with the system having, for example 4 poplar and two willow trees 26 equally spaced throughout it and surrounded by soil or root medium 28 to be tested. The plants are usually 4-12 months old.

The preferred phytoremediation test cell plants are described in my earlier patent, trees in the Salicaceae family Populous spp.& Salix spp. are planted in a growing medium.

The key phyto plant traits include perennial fast growth, extensive rooting, pest tolerant, adapted to climate, and yields a crop with harvested value for biomass, fiber and food.

The Salicaceae trees selected are capable of regrowth from cut stumps (coppicing) and are capable of fast wood growth with significant nutrient and water uptake.

The trees selected are capable of continuously maintaining a healthy root system even with coppiced harvest to provide both an attachment point and essential bioavailable feed to microbes.

While poplar and willow are preferred, red cedar, native grasses & forbes, and other deciduous trees can be planted.

Discharge is taken through either a drain tube 23 that discharges through a spout 24 and discharges via gravity through open drain valves 30 or discharges to the surface via a pump. In either case, the drainage water is then measured for volume and tested, for example, for the COC, such as ammonia nitrogen, phosphate and microbial pathogens,

If further desired, sufficient test cells can be subdivided into different variable sets that will allow statistical comparison between construction variables and operating variables, testing both effluent and media (soil) both treated and untreated.

If further desired, the test cells can be operated year-round to compare COC treatment efficacy in both the growing season and the dormant season.

The tree rhizosphere is the removal location for water pumped from the soil medium through the xylem to the leaf stomata where the water evaporates to the atmosphere.

The tree rhizosphere can be occasionally saturated by adding sufficient water to raise the phreatic surface into the roots and creating anaerobic or anoxic conditions.

The rhizosphere can drain by either mechanical methods such as gravity drainage or pumped drainage in addition to dewatering by evapotranspiration during the growing season with active photosynthesis and creating more aerobic conditions.

The oscillation of the phreatic surface in the rhizosphere increases the rate and efficacy of microbial breakdown for many petrochemical COC's such as chlorinated solvents, polychlorinated byphenyls, chlorinated wood preservatives for example.

The growing media used for testing COC removal from industrial and municipal waste water normally consists of a local agricultural soil with various amendments such as compost, bio solids, fertilizer, manure and other available beneficial additives to the rhizosphere.

The phytoremediation test cell can be filled with soil or other solid media excavated from a contaminated lagoon, landfill, spill site, industrial site, etc. mixed with selected amendments and planted with selected plants to allow future sampling to measure COC disappearance and fate.

Water coming through drain spout 24 can be collected and tested for the COC desired for removal and then compared with regulated discharge standards required to be achieved with mechanical and biological systems.

To remove or dispel the common doubt that phytoremediation does not work at all in the wintertime when photosynthesis is not active, the phytoremediation test cell can be tested during the winter months with their results used to dispel the common incorrect belief.

Root medium 2 which surrounds the elongated roots of say, for example, poplar or willow, in the test cell is either the contaminated soil or sludge from the area which is to be phytoremediated or it is soil from available fields capable of phyto remediating waste water that is irrigated into the rhizosphere for year-round COC removal.

In prototype tests, a series of test cells 10 can be set side by side with the drain spouts all oriented in the same direction. The water coming through drain spout 24 can be collected individually or all drained water can pour into a common collection drain pipe (not depicted) to allow for water removal and collection of even larger samples.

### EXAMPLES

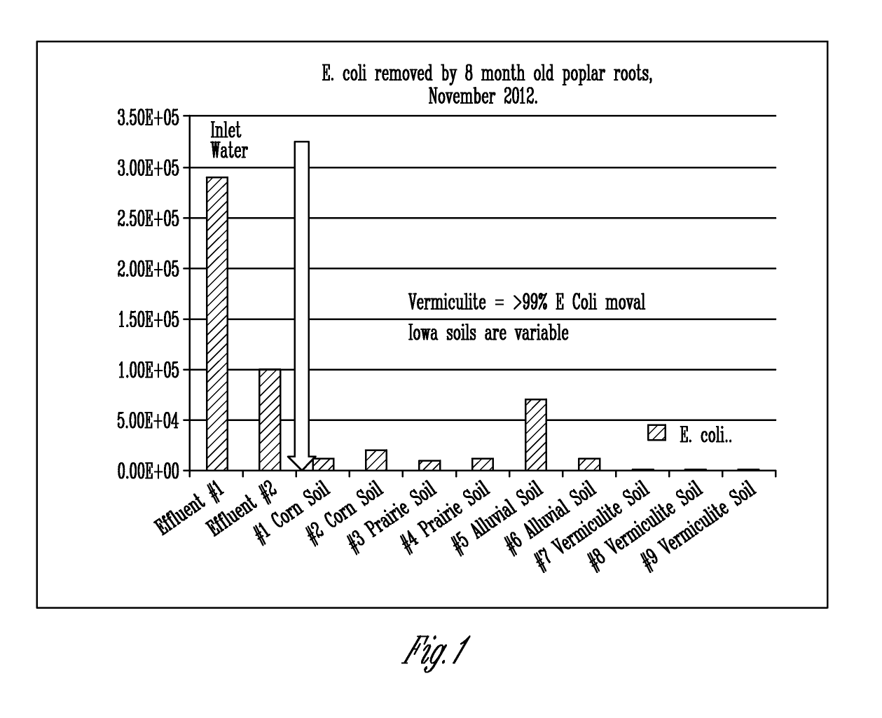

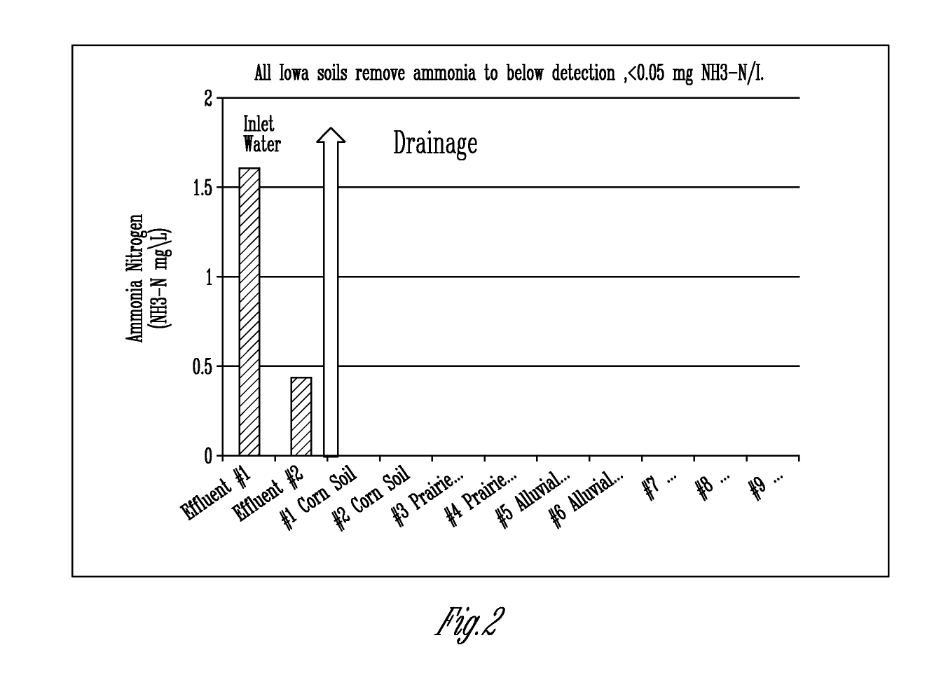

For the test cells (see FIG. 3) used to prepare the data shown in FIGS. 1 and 2, nine test cells were made, six using three different soil types and three with vermiculite. Drainage water from the phytoremediation test cell dripped into an aeration tank drain. The trees in the test cell were manually dosed three times per week using secondary effluent water from Aug. 1 through Dec. 2, 2011.

Dormancy occurred in mid-October. Trees were four poplars and two willows spaced evenly dispersed in each test cell.

Samples of raw effluent fed into the phytoremediation test cell and samples from each test cell were taken and then delivered to The University of Iowa Hygenic Lab for testing. As can be seen, the E. coli removal in, for example, vermiculite, was greater than 99%, and while it varied somewhat in the soil samples depending upon the sample being used, all were significantly reduced (FIG. 1).

With respect to ammonia nitrogen removal, all the soil samples, representing available typical Iowa soils, were all below the 0.5 milligrams of ammonia nitrogen detection limit and thus significantly reduced.

Conclusions which can be drawn from these used tests show the following trends:
1) all ammonia-nitrogen is removed to below the detection limit from the effluent water while in the root zone;
2) Significant E. coli pathogens are removed;
3) Phytoremediation treatment works during the normal dormant season.

Thus, the data from the test cell can be used to show that cost efficacy, predicted to be less than 50% of the mechanical/chemical/civil systems is significant

Moreover, the test cell can be visually demonstrated as effective by, for example, showing the graphs generated from the soil and wasted water in question. See FIGS. 1 and 2.

Because the actual field soil and available trees can be irrigated with the actual waste water requiring further tertiary treatment, the phytoremediation test cell is an accurate predictor demonstrating the first time with visual hard data its accuracy and efficiency.

To predict phyto treatment of contaminated soils and sludges, the solid meda with COC is obtained and placed into the phytoremediation test cell along with amendments blended into the treated sample. At time of planting, 2 to 4 inert plastic tubes are pressed through the media between the trees to provide isolated ‘blank’ samples that are exposed to similar conditions without the impact by roots. The COC treatment efficacy is determined by sampling the rhizosphere and the blank to measure pollutant concentrations and related chemical compounds such as break down compounds that show partial mineralization.

What is claimed is:

1. A phytoremediation test cell that mimics mature plant remediation properties, allowing a treatability study within one year comprising a growing season and dormant season, comprising:
a containment cell having an open top, and defining an elongated interior cavity,
said containment cell having a bottom with a drain outlet;
said cell elongated interior cavity being filled with a plurality of spaced apart deep rooted trees, the roots of which are surrounded and in direct contact with root medium, sufficiently filling said cavity such that substantially all roots have access to some root medium and some test water when it is poured through the open top.

2. The test cell of claim 1 wherein said trees are selected from the group consisting of member of the Salicaceae family.

3. The test cell of claim 1 wherein said trees are selected from the group of willow and poplar.

4. The test cell of claim 1 wherein the root medium is soil from an area being considered for phytoremediation.

5. The test cell of claim 1 wherein the elongated cavity is covered with an inert liner before the deep rooted trees and root medium are placed in said interior cavity.

6. The test cell of claim 1 wherein the drain outlet is formed of inert material, with respect to said root medium.

7. The test cell of claim 1 wherein the root medium is soil from an area being considered for phytoremediation.

8. The test cell of claim 1 wherein the test cell is irrigated with typical water containing pollutants from the area being considered for phytoremediation.

9. The test cell of claim 1 which has at least one media shield tube to allow some of the root media to be shielded from the irrigation water for comparison purposes.

10. The method of testing phytoremediation effectiveness, comprising:
placing 4-12 month old trees which are members of the Salicaceae family;
an elongated cavity surrounded with test soil, said cavity having a drain outlet at the bottom;
watering the trees with test water at a rate of at least three times per week, said test water containing pollutants to be removed; and
collecting the effluent draining through the elongated cavity; and
testing it for desired removal efficiency of said pollutants.
